(19) United States
(12) Patent Application Publication
(10) Pub. No.: US 2006/0023350 A1
(43) Pub. Date: Feb. 2, 2006

(54) Thin flexible disk drive having a stopper for supporting a flexible disk at a rear surface thereof

(75) Inventors: Hisateru Komatsu, Yamagata (JP); Makoto Konno, Yamagata (JP); Noriyuki Kobayashi, Yamagata (JP)

Correspondence Address: FRISHAUF, HOLTZ, GOODMAN & CHICK, PC, 220 5TH AVE FL 16, NEW YORK, NY, 10001-7708, US

(73) Assignee: Mitsumi Electric Co. Ltd., Tokyo (JP)

(21) Appl. No.: 11/067,447

(22) Filed: Feb. 24, 2005

(30) Foreign Application Priority Data
Jul. 28, 2004 (JP) 2004-220257

(51) Int. Cl. G11B 23/03

(52) U.S. Cl. 360/99.02

(57) ABSTRACT

A shutter driving mechanism has a disk shutter arm engaged with a corner portion of a shutter while a flexible disk is inserted in a thin flexible disk drive. The shutter driving mechanism drives the shutter so as to open the shutter by rotating the disk shutter arm. The shutter driving mechanism is rotatably mounted on a disk holder for holding the flexible disk. Integrally formed to the arm near a tip of the disk shutter arm, a stopper made of resin supports the flexible disk at a rear surface thereof so as to avoid crashing the flexible disk with a lower magnetic head on inserting/ejecting the flexible disk in/from the thin flexible disk drive. The stopper has a projection part projecting at a tip thereof upwards so that the projection part supports the flexible disk in line contact.

This application claims priority to prior Japanese patent application JP 2004-220257, the disclosure of which is incorporated herein by reference.

### BACKGROUND OF THE INVENTION

This invention relates to a thin flexible disk drive for use in recording information in and reading information out of a flexible disk.

In the manner which is well known in the art, the flexible disk drive (which may be hereinafter called “FDD” for short) of the type is a device for carrying out data recording and reproducing operation to and from a disk-shaped magnetic recording medium of the flexible disk (which may be hereinafter called “FD” for short) loaded therein. In addition, such a flexible disk drive is mounted or loaded in a portable electronic apparatus such as a laptop personal computer, a notebook-size personal computer, or the like.

The flexible disk drive of the type comprises a magnetic head for reading/writing data from/to the magnetic recording medium of the flexible disk, a carriage assembly for supporting the magnetic head at a tip thereof with the magnetic head movably along a predetermined radial direction to the flexible disk, a stepping motor for moving the carriage assembly along the predetermined radial direction, and a spindle motor for rotatably driving the magnetic recording medium with the flexible disk held. The spindle motor is one of direct-drive (DD) motors.

In recent years, the above-mentioned portable electronic apparatuses are more and more improved to be thinned. Following such improvement, the flexible disk drives mounted or loaded therein have also improved to be thinned. With thinning of the flexible disk drive, it is desired to miniaturize the flexible disk drive in a back-and-forth size. To achieve the thinning and the miniaturizing of the flexible disk drive, various regulations (restrictions) are imposed on parts constituting the flexible disk drive. That is, inasmuch as there are a lot of restrictions caused by omitting a space (thinning), a margin of design has a tendency to become smaller.

In a thin flexible disk drive, an eject shutter arm and an eject plate are generally constructed as different parts. The thin flexible disk drive capable of preventing an eject lever from erroneously operating is disclosed in U.S. Pat. No. 6,507,453 issued to Hisateru Komatsu et al.

In the manner which will later be described in conjunction with FIGS. 1 through 6, an exclusive upper magnetic head guard is required to protect a lower magnetic head in a conventional thin flexible disk drive. Accordingly, the conventional thin flexible disk drive is disadvantageous in that it has increased parts and increased assembling processes

In addition, a flexible disk drive realizing to reduce size in the depth direction is proposed in Japanese Unexamined Patent Application Publication No. H8-203221 or JP-A 8-203221. In the flexible disk drive disclosed in JP-A 8-203221, an assembly composed of a stepping motor and of a feed screw is arranged in such a way that it is situated in a deep part of a main frame on the side opposite to an insertion port of a flexible disk and that it is adjacent to one out of the right and left side edges of the main frame. The feed screw is extended in parallel with one out of the right and left side edges of the main frame. A carriage assembly is parallel with a main surface of the main frame so as to be extended to a direction perpendicular to the feed screw.

On the other hand, a shutter driving mechanism of a magnetic disk is known in Japanese Utility Model Publication No. 2598686 or JP-Y 2598686. In the shutter driving mechanism, it is possible to certainly carry out opening and closing operation of a shutter of a flexible disk by certainly engaging an arm with the shutter. In addition, a protection device of a magnetic head is known in Japanese Unexamined Utility Model Publication No. Hei 6-38055 or JP-U 6-38055. In the protection device, it is possible to reduce the number of parts to realize a cost reduction and thinness of a drive by forming, by a signal plate spring, a lower head guard mounted on a bottom surface of a flexible disk drive.

Furthermore, Japanese Unexamined Utility Model Application Publication No. H5-55344 or JP-U 5-55344 discloses a flexible disk drive for preventing an accident where a slide shutter slashes with a magnetic head caused by suddenly ejecting a flexible disk to damage the magnetic head when an ejection operation is carried out with an insertion port of a flexible disk drive inclined downwards or the like. In the flexible disk drive disclosed in JP-U 5-55344, a shutter opening and closing lever has a tip portion provided with a hook. The hook is formed so as to be inserted within a gap portion of the slide shutter of the flexible disk. On ejecting the flexible disk, the hook is engaged with the slide shutter until the shutter opening and closing lever returns to a predetermined position and then the flexible disk is not apart from the shutter opening and closing lever. Accordingly, the flexible disk does not move in an ejection rejection at a speed than faster than a return speed of the shutter opening and closing lever and it is therefore possible to prevent a edge portion of a shutter window from clashing with the magnetic head from a side direction due to closing of the slide shutter adjacent to the magnetic head.

However, JP-U 5-55344 merely discloses protection of the magnetic head on ejecting the flexible disk and never discloses protection of the magnetic head on inserting the flexible disk.

### SUMMARY OF THE INVENTION

It is therefore an object of the present invention to provide a thin flexible disk drive which is capable of protecting a lower magnetic head without increasing the number of parts.

It is another object of the present invention to provide a thin flexible disk drive of the type described, which is capable of protecting the lower magnetic head without increasing the number of assembling processes.

Other objects of this invention will become clear as the description proceeds.

On describing the gist of an aspect of this invention, it is possible to be understood that a thin flexible disk drive in which a flexible disk is inserted. The flexible disk comprises a slidable shutter. The thin flexible disk drive comprises upper and lower magnetic heads which are disposed in a portion corresponding to the slidable shutter when the flexible disk is inserted in the thin flexible disk drive. A disk holder is for holding the flexible disk. A shutter driving mechanism has an arm engaged with a corner portion of the shutter when the flexible disk is inserted in the thin flexible disk drive. The shutter driving mechanism drives the shutter so as to open the shutter by rotating the arm.

According to the aspect of this invention, the shutter driving mechanism is rotatably mounted on the disk holder. The thin flexible disk drive further comprises a stopper integrally formed to the arm near a tip of the arm. The stopper supports the flexible disk at a rear surface thereof so as to avoid crashing the flexible disk with the lower magnetic head on inserting/ejecting the flexible disk in/from the thin flexible disk drive. The stopper preferably may be made of resin. The stopper desirably may have a projection part projecting at a tip thereof upwards so that the projection part supports the flexible disk in line contact. Preferably, the arm may serve also as an eject lever for ejecting the flexible disk from the thin flexible disk drive.

### BRIEF DESCRIPTION OF THE DRAWINGS

FIG. 1 is a plan view of a conventional thin flexible disk drive;

FIG. 2 is a plan view of the thin flexible disk drive illustrated in FIG. 1 in a state while a floppy disk is inserted therein;

FIG. 3 is a plan view of the thin flexible disk drive illustrated in FIG. 1 in a state where the flexile disk is completely received therein;

FIG. 4 is a plan view of a disk holder assembly for use in the thin flexible disk drive illustrated in FIG. 1;

FIG. 5A is a plan view of an eject lever for use in the thin flexible disk drive illustrated in FIG. 1;

FIG. 5B is a right side view of the eject lever illustrated in FIG. 5A;

FIG. 5C is a rear view of the eject lever illustrated in FIG. 5A;

FIG. 6 is a plan view of a flexible disk driven by the flexible disk drive illustrated in FIG. 1;

FIG. 7 is a plan view showing a main part of a thin flexible disk drive according to an embodiment of this invention;

FIG. 8 is a perspective view showing a carriage assembly for use in the thin flexible disk drive illustrated in FIG. 7;

FIG. 9 is a plan view showing an assembled body, which is combined with a main frame illustrated in FIG. 7, into which an eject base, an eject plate, and a disk holder are assembled;

FIG. 10 is a bottom view of the assembled body illustrated in FIG. 9;

FIG. 11 is a plan view showing a state where the assembled body illustrated in FIG. 9 is assembled to the main frame illustrated in FIG. 7;

FIG. 12A is a plan view of a disk holder for use in the thin flexible disk drive illustrated in FIG. 7;

FIG. 12B is a left side view of the disk holder illustrated in FIG. 12A;

FIG. 12C is a right side view of the disk holder illustrated in FIG. 12A;

FIG. 12D is a bottom view of the disk holder illustrated in FIG. 12A;

FIG. 13 is a plan view showing an eject lever for use in the thin flexible disk drive illustrated in FIG. 7 at a state where the flexible disk is inserted therein;

FIG. 14A is a plan view showing an arm part constituting the elect lever illustrated in FIG. 13;

FIG. 14B is a front view of the arm part illustrated in FIG. 14A;

FIG. 14C is a left side view of the arm part illustrated in FIG. 14A;

FIG. 15A is a plan view showing a lever bush constituting the elect lever illustrated in FIG. 13;

FIG. 15B is a front view of the lever bush illustrated in FIG. 15A;

FIG. 16 is left side view of the eject lever where the arm part illustrated in FIGS. 14A to 14C and the lever bush illustrated in FIGS. 15A and 15B are assembled together with a position relationship between the flexible disk inserted in the thin flexible disk drive illustrated in FIG. 7 and a lower magnetic head mounted on a tip portion of a lower carriage in a carriage assembly;

FIG. 17 is a bottom view showing an arrangement relationship between the assembled body and the flexible disk in a state while the flexible disk is inserted in the thin flexible disk drive illustrate in FIG. 7; and

FIG. 18 is a bottom view showing an arrangement relationship between the assembled body and the flexible disk in a state where the flexible disk is completely received in the thin flexible disk drive illustrated in FIG. 7.

### DESCRIPTION OF THE PREFERRED EMBODIMENT

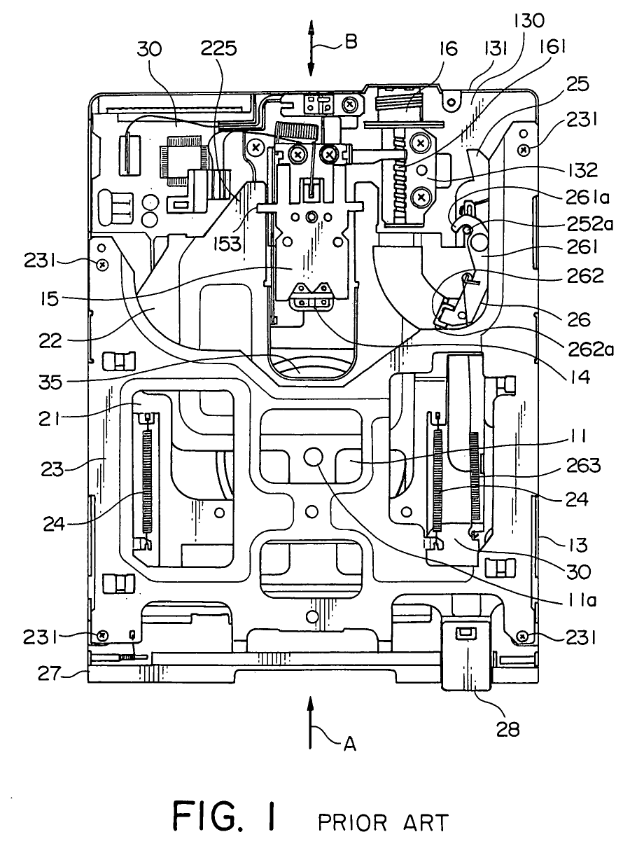

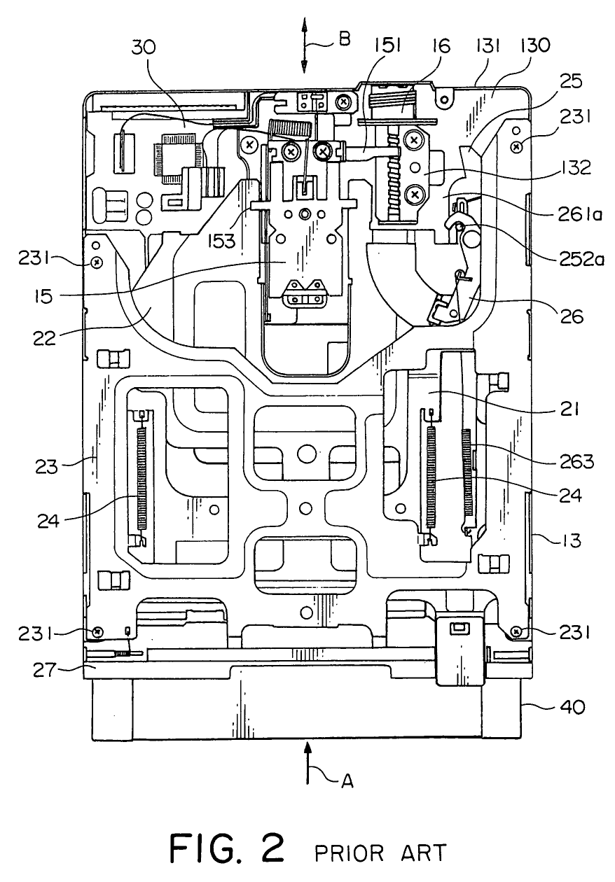

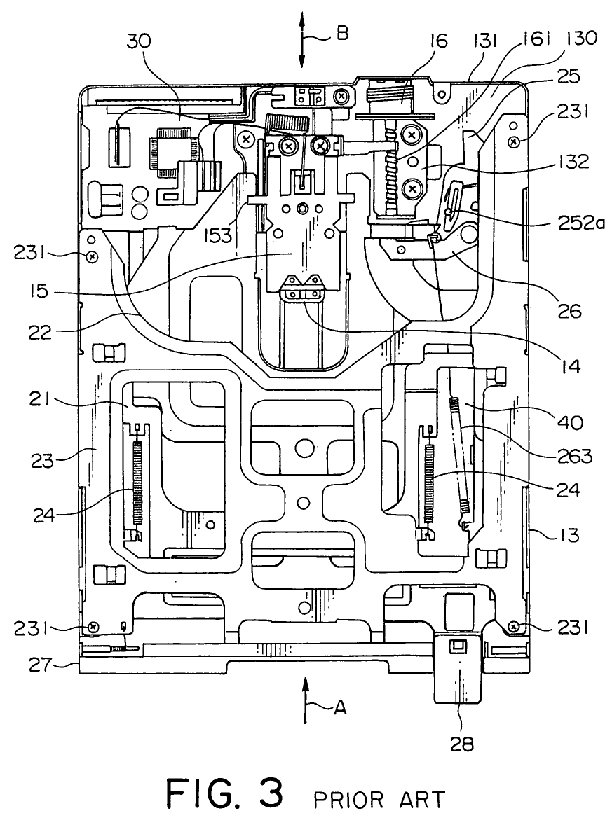

Referring to FIGS. 1, 2, and 3, a conventional thin flexible disk drive will be described at first in order to facilitate an understanding of the present invention. The illustrated thin flexible disk drive is disclosed in the above-mentioned U.S. Pat. No. 6,507,453. The illustrated thin flexible disk drive is a floppy disk drive of a 3.5-inch type for driving a flexible disk 40 of a 3.5-inch type which will later described. FIG. 1 is a plan view of the thin flexible disk drive in a state where the flexible disk 40 is not inserted therein. FIG. 2 is a plan view of the thin flexible disk drive in a state while the flexible disk 40 is inserted therein. FIG. 3 is a plan view of the thin flexible disk drive in a state where the flexible disk 40 is completely received therein. Each of FIGS. 1, 2, and 3 shows a state where an upper cover (not shown) is removed from the thin flexible disk drive.

The flexible disk 40 is inserted or loaded in the thin flexible disk drive from a direction indicated by an arrow A in FIGS. 1 through 3. The loaded flexible disk 40 is held on a disk table 11 having a rotation axis 11a. In this event, the rotation axis 11a coincides with a center axis of the flexible disk 40. The disk table 11 is rotatably supported on a motor main surface of a motor frame (not shown) mounted on a frame main surface 130 of a main frame 13. Accordingly, the rotation axis 11a of the disk table 11 has an axial direction (i.e. a direction perpendicular to the plane of the drawing sheet) which extends in parallel with a thick direction of the main frame 13. The disk table 11 is rotatably driven by a spindle motor or a direct-drive (DD) motor 35 mounted on the motor main surface of the motor frame, thereby a magnetic recording medium of the flexible disk 40 rotates. In addition, on the frame main surface 130 of the main frame 13 and on the motor main surface of the motor frame is attached a printed substrate 30 on which a number of electronic parts (not shown) are mounted.

The thin flexible disk drive comprises a pair of upper and lower magnetic heads 14 (only the upper magnetic head is illustrated) for reading/writing data from/to the magnetic recording medium of the flexible disk 40. The magnetic heads 14 are supported in a carriage assembly 15 at a tip thereof that is laid in the thin flexible disk drive at a rear side. That is, the carriage assembly 15 comprises an upper carriage for supporting the upper magnetic head 14 and a lower carriage for supporting the lower magnetic head. The carriage assembly 15 is disposed over the frame main surface 130 of the main frame 13 and is apart from the frame main surface 130 of the main frame 13 in the manner which will later be described. The carriage assembly 15 supports the magnetic heads 14 movably along a predetermined radial direction (i.e. a direction indicated by an arrow B in FIGS. 1, 2, and 3) to the floppy disk 40.

In addition, the main frame 13 has at the rear side a frame rear wall 131 on which a stepping motor 16 is fixed. The stepping motor 16 linearly drives the carriage assembly 15 along the predetermined radial direction B. More specifically, the stepping motor 16 has an axis of rotation (a driving shaft) 161 which extends in parallel with the predetermined radial direction B and which is threaded to form a male screw. The driving shaft 161 has a tip which penetrates a hole bored in a pedestal portion 132 attached on the frame main surface 130 of the main frame 13. At any rate, the driving shaft 161 of the stepping motor 16 is defined so as to extend in parallel with the predetermined radial direction B and the tip thereof is rotatably held.

On the other hand, the carriage assembly 15 comprises an arm 151 which extends from the lower carriage to the driving shaft 161. The arm 151 has a leading edge which is engaged with the root in the male screw of the driving shaft 161. Therefore, when the driving shaft 161 of the stepping motor 16 rotates, the leading edge of the arm 151 moves along the root in the male screw of the driving shaft 161, thereby moving the carriage assembly 15 along the predetermined radial direction B. At any rate, the stepping motor 16 serves as a driving arrangement for moving the carriage assembly 15 along the predetermined radial direction B.

Inasmuch as the driving shaft 161 of the stepping motor 16 is disposed at one side of the carriage assembly 15, the one side of the carriage assembly 15 is movably supported by the driving shaft 161 and is apart from the frame main surface 130 of the main frame 13. However, because support occurs by the driving shaft 161, it is difficult to dispose the whole of the carriage assembly 15 apart from the frame main surface 130 of the main frame 13. For this purpose, a guide bar (not shown) guides the carriage assembly 15 with the carriage assembly 15 supported at another side thereof. That is, the guide bar is opposed to the driving shaft 161 of the stepping motor 16 with the carriage assembly 15 inserted between the guide bar and the driving shaft 161. The guide bar extends in parallel with the predetermined radial direction B and has one end and another end which are fixed on the frame main surface 130 of the main frame 13. The guide bar guides the carriage assembly 15 along the predetermined radial direction B. As a result, the whole of the carriage assembly 15 is disposed apart from the frame main surface 130 of the main frame 13.

In addition, a flexible printed circuit (FPC) (not shown) extends from the carriage assembly 15 to the vicinity of the guide bar and the flexible printed circuit is electrically connected to the printed substrate 30 attached to the frame main surface 130 of the main frame 13.

The lower carriage of the carriage assembly 15 serves as a supporting frame for supporting the carriage assembly 15 slidably along the guide bar. The lower carriage has a projecting portion (not shown) which projects into the frame main surface 130 of the main frame 13 at a side of the guide bar. The guide bar is slidably fitted in the projection portion.

The thin flexible disk drive further comprises an eject plate 21 and a disk holder 22. Each of the main frame 13, the eject plate 21, and the disk holder 22 is formed to perform die cutting, press working, and bending of a metal plate. The eject plate 21 is mounted on the frame main surface 130 of the main frame 13 slidably along the insertion direction A of the floppy disk 40 and an opposite direction (i.e. backward and forward).

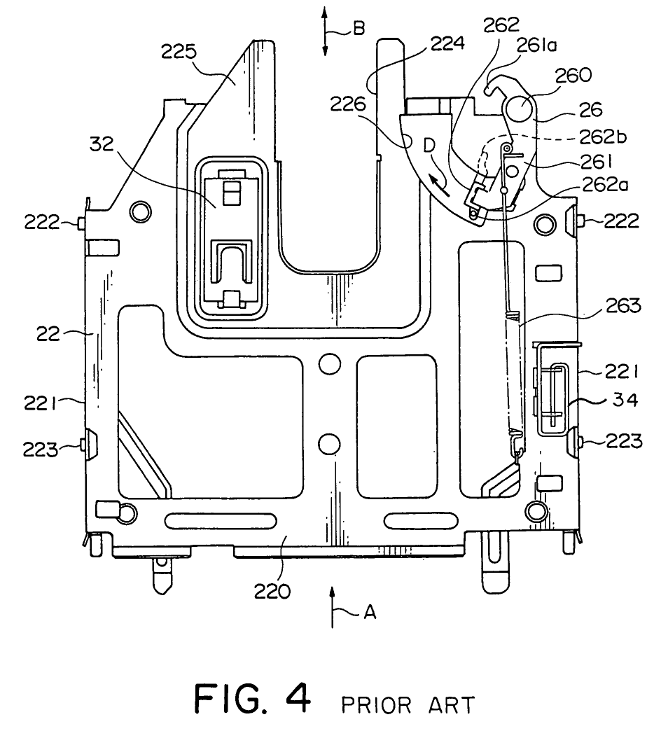

Referring to FIG. 4, the description will proceed to the disk holder 22. The disk holder 22 is disposed under a plate main surface of the eject plate 21. The disk holder 22 comprises a holder principal surface 220 and a pair of holder side walls 221 which is formed at both side ends of the holder principal surface 220 and which is opposed to each other. Each of the both holder side walls 221 is provided with a pair of projection pins 222 and 223 formed on a front side and a rear side thereof, respectively, to protrude outward. The projection pins 222 and 223 are inserted in guide slits (not shown) formed on plate side walls (not shown) of the eject plate 21.

In addition, the disk holder 22 has a rectangular opening section 224 at a center portion in a back or rear side in the insertion direction A. The rectangular opening section 224 is laid in a corresponding position of the upper carriage of the carriage assembly 15 and extends in the predetermined radial direction B. So as to enclose the opening section 224, a U-shaped swelled portion 225 is formed where the holder principal surface 220 of the disk holder 22 swells at periphery upwards.

On the other hand, the carriage assembly 15 comprises a pair of side arms 153 (FIGS. 1, 2, 3) which extends in a lateral direction perpendicular to a longitudinal direction of the carriage assembly 15. The side arms 153 are located on or over the swelled portion 225. In the manner which will later be described, in a state where the flexible disk 40 is ejected from the disk holder 22, the side arms 153 engages with the swelled portion 225, thereby the pair of upper and lower magnetic heads 14 are apart from each other. In addition, the disk holder 22 has an additional opening section 226 at a right-hand side of the opening section 224 in the back side of the insertion direction A. The opening section 226 has a shape so as to allow a lever part of the eject lever (which will later be described) rotatably move.

As shown in FIGS. 1, 2, and 3, an upper surface of the main frame 13 is covered by a sub-frame 23. The sub-frame 23 is also called an eject base. The sub-frame 23 is fixed on the main frame 13 by screws 231 at four corners. Between the sub-frame 23 and the plate main surface 210 of the eject plate 21, a pair of eject springs 24 is bridged. In the vicinity of the carriage assembly 15 on the main frame 13, an eject lever depicted at 25 is formed to rotatably move.

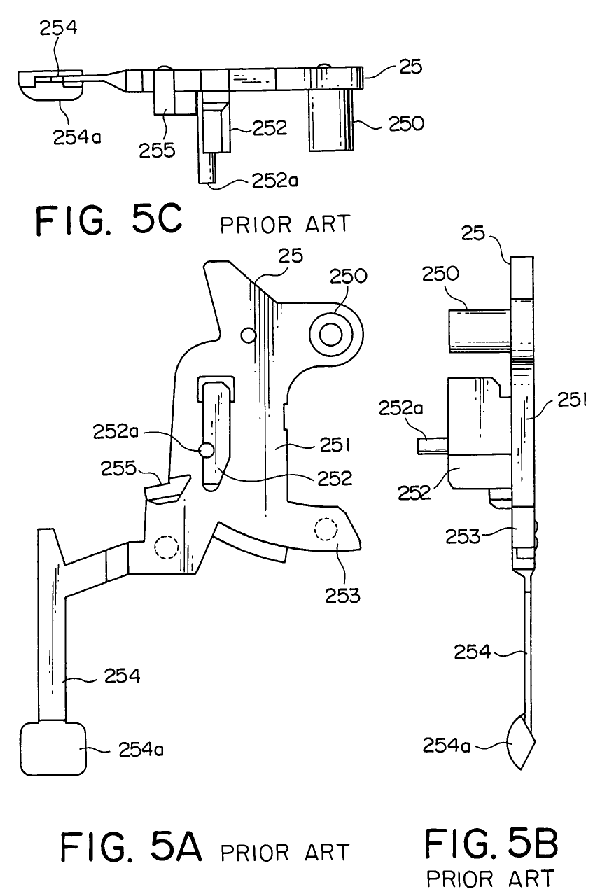

FIGS. 5A, 5B, and 5C collectively show structure of the eject lever 25. FIG. 5A is a plan view of the eject lever 25, FIG. 5B is a right side view of the eject lever 25, and FIG. 5C is a rear view of the eject lever 25. On the main frame 13, a rod pin (not shown) stands up which extends upwards from the frame main surface 130 thereof at a predetermined position in right side and forward of the frame main surface 130. The eject lever 25 comprises a cylindrical part 250 in which the rod pin is inserted, an eject arm part (an eject lever part) 251 extending from the cylindrical part 240 in a radial direction, an eject projection part 252 which is formed in the eject arm part 251 and which extends upwards. The eject lever 25 further comprises an eject stop part 253 which has an arc-shaped and which extends from a side of a free end of the eject arm part 251 in a circumferential direction. In the eject lever 25, an eject lever spring (not shown) is attached around the cylindrical part 250 and the eject lever spring urges the eject lever 25 in a counterclockwise direction on the plane of the drawing sheet.

The eject projection part 252 of the eject lever 25 is engaged with a front edge of the floppy disk 40 (which will later be described) to control a sliding operation of the eject plate 21 backward and forward.

The eject lever 25 further comprises a tongue part 254 which extends in parallel to the eject arm part 251 toward the spindle motor 35 (FIG. 1). The tongue part 254 has a tip part 254a which is swelled. The tip part 254a is for avoiding crashing the flexible disk 40 with the lower magnetic head when the flexible disk 40 is loaded in the thin flexible disk drive.

In addition, the eject projection part 252 of the eject lever 25 further has an eject protrusion 252a which protrudes upwards. The eject protrusion 252a is engaged with a shutter hook part 261a of a disk shutter arm 26 which will later be described.

The eject lever 25 further comprises an eject stopper part 255. The eject stopper part 255 is for preventing the disk shutter arm 26 from returning back to an initial position by engaging with the later-described disk shutter arm 26 when the flexible disk 40 is completely received in the thin flexible disk drive.

Turning back to FIG. 4, the disk holder 22 has a right-upper corner part on which the disk shutter arm 26 is rotatably mounted around a shutter arm pin 260. The disk shutter arm 26 comprises a shutter arm part (a shutter lever part) 261 extending from the right-upper corner part in a radial direction and a shutter arm bush 262 which is mounted on a tip portion of the shutter arm part 261 and which extends downwards.

The shutter arm part 261 has the shutter hook part 261a which engages with the eject protrusion 252a of the above-mentioned eject lever 25. As shown in FIG. 4, the shutter arm bush 262 is freely inserted in the opening part 226 of the above-mentioned disk holder 22. In addition, an tip part 262a of the shutter arm bush 262 is engaged with an upper end of a right-hand side edge of the shutter of the later-described flexible disk 40 to control opening and closing of the shutter. The shutter arm bush 262 further has a shutter projection part 262b. The shutter projection part 262b is engaged with the eject stopper part 255 of the above-mentioned eject lever 25 when the floppy disk drive 40 is completely received in the thin floppy disk drive.

As illustrated in FIG. 4, the disk shutter arm 26 is urged by a shutter arm spring 263 around the shutter arm pin 260 counterclockwise. That is, the shutter arm spring 263 is bridged between the shutter arm part 261 of the disk shutter arm 26 and the disk holder 22. An upper magnetic head guard 32 is mounted on the swelled portion 225 of the disk holder 22. The upper magnetic head guard 32 is for protecting the upper magnetic head 14 so that the flexible disk 40 is not hit to the upper magnetic head 14 on inserting the flexible disk 40.

In addition, a reverse direction insertion preventing spring 34 is mounted in the holder principal surface 220 of the disk holder 22 at right side. A combination of the disk holder 22, the disk shutter arm 26, the shutter arm pin 260, the upper magnetic head guard 32, and the reverse direction insertion preventing spring 34 constitutes a disk holder assembly.

Turning back to FIGS. 1 to 3, the main frame 13 has a front end section on which a front panel or bezel 27 is attached. The front bezel 27 has a bezel opening (not shown) for taking the flexible disk 40 in and out and a bezel door (not shown) for opening and shutting the bezel opening. Into the front bezel 27, an eject button 28 projects movably backward and forward. The eject button 28 is fitted in a protrusion part (not shown) which protrudes from a front end of the eject plate 21 forwards.

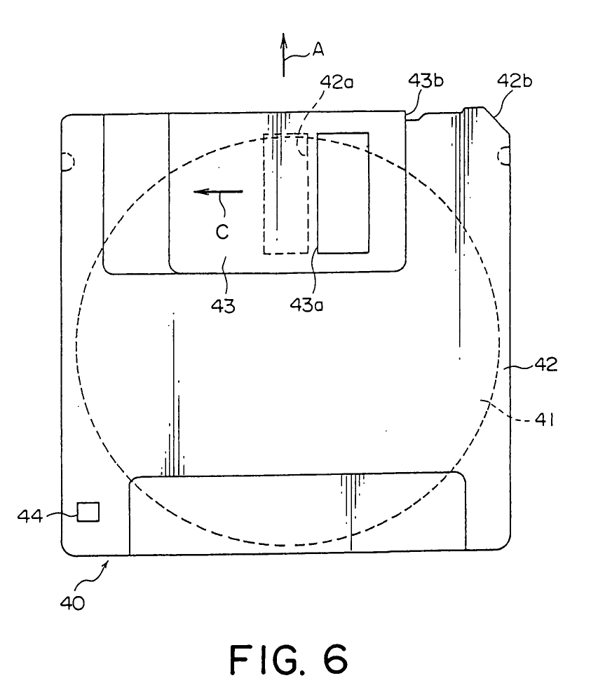

Referring to FIG. 6, the description will proceed to the flexible disk (FD) 40 driven by the thin flexible disk drive (FDD) illustrated in FIGS. 1 through 3. The illustrated flexible disk 40 comprises a disk-shaped magnetic recording medium 41, a shell 42 for covering or receiving the magnetic recording medium 41, and the shutter depicted at 43 slidably in an opening direction indicated by an arrow C in FIG. 6.

The shutter 43 has a shutter window 43a. The shutter 43 is urged by a spring member (not shown) in a closing direction reverse to the opening direction C. The shell 42 has a head window 42a to enable an access of the magnetic recording medium 41 by the magnetic heads 14 of the above-mentioned thin flexible disk drive. In a state where the flexible disk 40 is not loaded in the thin flexible disk drive, the head window 42a is covered by the shutter 43 as shown in FIG. 6. When the flexible disk 40 is loaded in the thin flexible disk drive, the tip part 262a of the shutter arm bush 262 in the disk shutter arm 26 engages with the upper end 43b of the right-hand side edge of the shutter 43 to slide the shutter 43 in the opening direction C.

The shell 42 has a chamfered portion 42b at a corner portion in upper and right-hand side thereof. The chamfered portion 42b is for preventing reverse insertion (wrong insertion in a vertical direction or the insertion direction A). In addition, a write protection hole 44 is bored in the shell 42 at a corner portion in rear and left-hand side in the insertion direction A of FIG. 6.

In the manner known in the art, in the flexible disk 40 driven by the thin flexible disk drive, the magnetic recording medium 41 accessed by the magnetic heads 14 (FIG. 1) has a plurality of tracks (not shown) on a surface thereof that serve as paths for recording data and that are formed in a concentric circle along a radial direction. The flexible disk 40 has eighty tracks on one side which include the most outer circumference track (the most end track) TR00 and the most inner circumference track TR79.

With this structure, when the flexible disk 40 is not loaded in the thin flexible disk drive, the shutter hook part 261a of the disk shutter arm 26 is engaged with the eject protrusion 252a of the eject lever 25 so as to control or regulate the rotation movement of the eject lever 25 as shown in FIG. 1. As a result, it is possible to prevent the eject lever 25 from rotating at a predetermined rotation angle or more as far as the flexible disk 40 is not loaded in the thin flexible disk drive. In other words, it is possible to prevent the eject lever 25 from erroneously operating although shock or impact is given in the thin flexible disk drive.

Referring now to FIGS. 1 through 6, the description will proceed to operation in a case where the flexible disk 40 is loaded in the thin flexible disk drive and operation in a case where the flexible disk 40 is ejected from thin flexible disk drive. The description will first be made about the operation on loading the flexible disk and subsequently the description will be made about the operation on ejecting the flexible disk 40.

Before the flexible disk 40 is loaded in the thin flexible disk drive, the eject lever 25 and the disk shutter arm 26 are put into a state illustrated in FIG. 1. That is, the eject protrusion 252a of the eject lever 25 is engaged with the shutter hook part 261a of the disk shutter arm 26. In this state, the plate stopper portion (not shown) of the eject palate 21 is engaged with the eject stop part 253 of the eject lever 25.

In addition, in this state, the projection pins 222 and 223 of the disk holder 22 are located in guide slots (not shown) of the eject plate 21 at upper side and the disk holder 22 is put in an risen position. This risen position is a position where the floppy disk 40 can be received in the thin floppy disk drive. Furthermore, in this state, the side arms 153 of the carriage assembly 15 are engaged on the swelled portion 225 of the disk holder 22 and the upper magnetic head 14 is put in an upper position apart from the lower magnetic head.

In this state, a user holds the flexible disk 40 and inserts the flexible disk 40 in the thin flexible disk drive, as shown in FIG. 2, in the insertion direction A in a normal state with the front edge of the flexible disk 40 put to the bezel door of the front bezel 27. Thereupon, as shown in FIG. 2, an upper end 43b of the right-hand side edge of the shutter 43 engages with the tip part 262a of the shutter arm bush 262 of the disk shutter arm 26. When the flexible disk 40 is further pushed and put forward from this time instant (place) in opposition to the urging force of the shutter arm spring 263 mounted in the disk shutter arm 26, the shutter arm bush 262 of the eject shutter arm 26 moves in the opening portion 226 in a clockwise direction indicated by an arrow D of FIG. 4. Accompanied with this, the shutter 43 of the flexible disk 40 slides in the opening direction C of FIG. 6 in opposition to the urging force of the spring member. Accordingly, the shutter 43 gradually opens the head window 42a.

And then the shutter 43 of the flexible disk 40 sufficiently opens by the eject shutter arm 26. Just before the flexible disk 40 is substantially and completely received in the thin flexible disk drive, the front edge of the flexible disk 40 engages with the eject projection part 252 of the eject lever 25. In this event, inasmuch as engagement between the eject protrusion 252a of the eject lever 25 and the shutter hook part 261a of the disk shutter arm 26 is released, the eject lever 25 is put into a state to enable the eject lever 25 to rotate in the clockwise direction.

When the flexible disk 40 is further pushed and put forward in the thin flexible disk drive, the eject lever 25 rotates in a clockwise direction in opposition to the eject lever spring mounted thereon and engagement between the eject stop part 253 of the eject lever 25 and the plate stopper part of the eject plate 21. Thereby, the eject plate 21 slightly slides forwards (the opposite direction for the insertion direction A). This is because the eject plate 21 is urged by the eject springs 24 forwards.

On the other hand, inasmuch as the eject plate 21 slides forwards, the disk holder 22 comes down. This is because the projection pins 222 and 223 formed on the holder side walls 221 of the disk holder 22 are inserted in the guide slits formed in the plate side walls of the eject plate 21.

Accordingly, engagement between the side arms 153 of the carriage assembly 15 and the swelled portion 225 of the disk holder 22 is released and the upper carriage of the carriage assembly 15 also comes down. As a result, the magnetic disk medium 41 of the flexible disk 40 is put between the pair of upper and lower magnetic heads 14 mounted on the carriage assembly 15 at the tip part thereof. In this event, inasmuch as the eject stopper part 255 of the eject lever 25 is engaged with the projection part 262b of the shutter arm bush 262 of the disk shutter arm 26, it is possible to prevent the disk shutter arm 26 from returning back to an original position. In addition, inasmuch as the eject plate 21 slightly slides forwards, the eject button 28 also slightly protrudes from the front bezel 27 forwards. This state is illustrated in FIG. 3.

Thereafter, in the manner known in the art, it is possible to read and write data from and in the magnetic disk medium 41 of the flexible disk 40 using the magnetic heads 14.

Now, the description will be made about the operation in the case where the floppy disk 40 is ejected from the disk holder 22.

In this event, the user pushes the eject button 28 in the insertion direction A backwards. Accordingly, the eject plate 21 slides on the main frame 13 in the insertion direction A backwards. With this operation, the projection pins 222 and 223 of the disk holder 22 move along the guide slits of the eject plate 21 and the disk holder 22 comes up. Accordingly, the pair of side arms 153 of the carriage assembly 15 are engaged with the swelled portion 225 of the disk holder 22 and the pair of upper and lower magnetic heads 14 supported on the carriage assembly 15 at the tip part thereof are apart from the magnetic recording medium 41 of the flexible disk 40. When the eject button 28 is furthermore pushed in the insertion direction A backwards, the disk holder 22 is put at a predetermined defined upper position and the eject lever 25 rotates counterclockwise by the urging force of the eject lever spring.

At the same time, engagement between the eject stopper part 255 of the eject lever 25 and the shutter projection part 262b of the shutter arm bush 262 of the disk shutter arm 26 is released and the disk shutter arm 26 rotates, by the urging force of the shutter arm spring 263, counterclockwise in the opposite direction to the direction indicated by the arrow D of FIG. 4. Accordingly, the floppy disk 40 received in the disk holder 22 is pushed out in the opposite direction to the insertion direction A and the floppy disk 40 is ejected from the thin floppy disk drive. In this state, inasmuch as the eject stop part 253 of the eject lever 25 is engaged with the plate stopper part of the eject plate 21, it is possible to prevent the eject plate 21 from moving toward the front bezel 27.

In the manner which is described above, in the conventional flexible disk drive, in order to avoid crashing the flexible disk 40 with lower magnetic head on inserting and ejecting of the flexible disk 40, the conventional flexible disk drive comprises an exclusive part therefor (the tip part 254a of the eject lever 25) to protect the lower magnetic head (i.e. to prevent the lower magnetic head from being caught and being broken). In addition, such means for protecting the lower magnetic head is called a lower magnetic head guard.

In the manner which is described above, the exclusive upper magnetic head guard is required to protect the lower magnetic head in the conventional thin flexible disk drive. Accordingly, the conventional thin flexible disk drive is disadvantageous in that it has increased parts and increased assembling processes, as mentioned in the preamble of the instant specification.

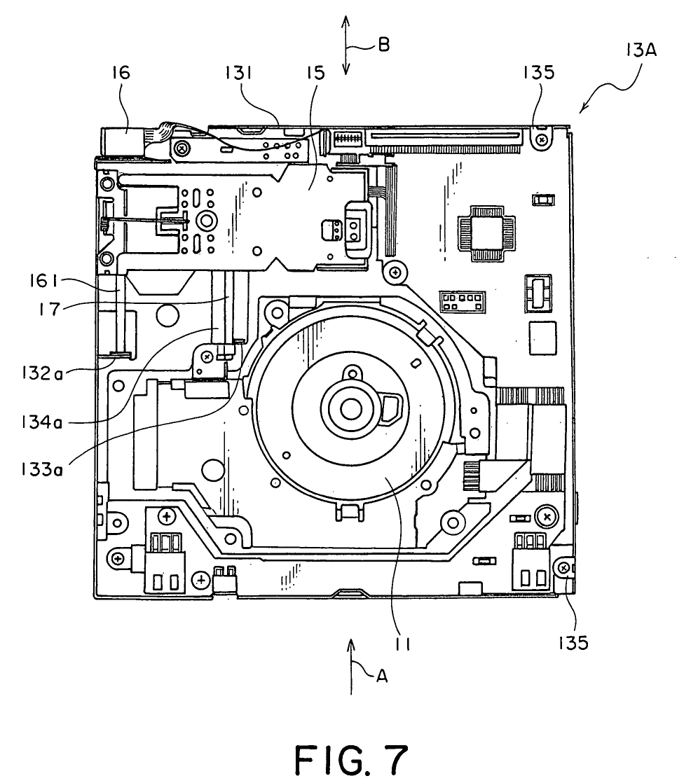

FIG. 7 shows a main frame 13A of a thin flexible disk drive according to an embodiment of this invention. The illustrated main frame 13A is different from the main frame 13 of the conventional thin flexible disk drive illustrated in FIGS. 1 through 3 and has a reduced size in the depth direction.

The illustrated main frame 13A has a wide size and a depth size which are slightly larger than those of the flexible disk 40 (FIG. 6) and both of which are within +10 mm. The flexible disk 40 is inserted or loaded in the thin flexible disk drive from a direction indicated by an arrow A. The stepping motor 16 is fixed to the main frame 13A at a position adjacent to a left-side wall in both side walls of the main frame 13A by using a part of the frame rear wall 131.

The stepping motor 16 has the axis of rotation (the driving shaft) 161 which extends in parallel with the predetermined radial direction B. The driving shaft 161 is threaded to form the male screw. The driving shaft 161 has a tip which is rotatably supported by a supporting part 132a formed by cutting and raising the main frame 13A. The driving shaft 161 is engaged with a part of the carriage assembly 15 for mounting magnetic heads (which will later be described) thereon. As a result, by making the driving shaft 161 rotation movement, the carriage assembly 15 moves along the predetermined radial direction B of the flexible disk 40. On the main frame 13A, a guide bar 17 is also fixed so as to extend in parallel with the driving shaft 161 by two supporting parts 133a (only one of which is illustrated in FIG. 7) formed by cutting and raising the main frame 13A.

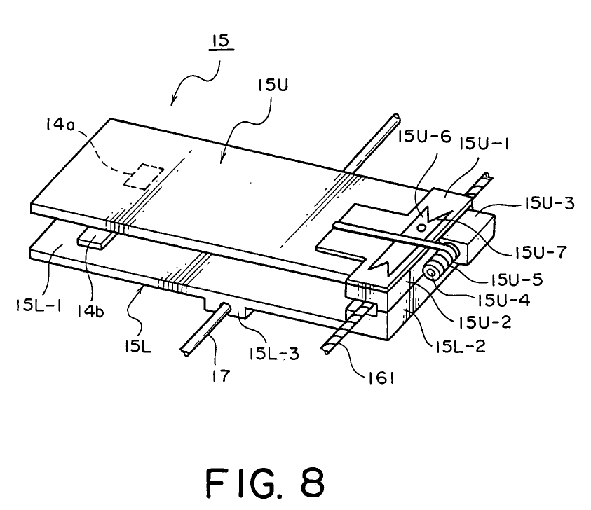

Referring to FIG. 8 in addition to FIG. 7, the description will be made about a relationship among the carriage assembly 15, the driving shaft 16, and the guide bar 17.

The carriage assembly 15 comprises an upper carriage 15U and a lower carriage 15L. The upper carriage 15U and the lower carriage 15L have one tip portion on which an upper magnetic head 14a and a lower magnetic head 14b are mounted, respectively. The upper carriage 15U enables to open upwards in the figure. In a state where the upper carriage 15U opens, the flexible disk 40 is inserted between the upper carriage 15U and the lower carriage 15L. After the flexible disk 40 is inserted, each of the magnetic heads 14a and 14b is put into a closed state so as to come close to the magnetic recording medium 41 of the flexible disk 40.

The upper carriage 15U comprises a plate-shaped arm. On the other hand, the lower carriage 15L comprises a plan plate 15L-1 for supporting the lower magnetic head 14b and a projection part 15L-2 provided at an end portion opposite to the lower magnetic head 14b. The projection part 15L-2 is combined with a projection part 15U-2 which is linked with the upper carriage 15U through a metallic linking plate 15U-1. The upper carriage 15U comprises a spring mounting part 15U-3 which projects rightwards in FIG. 8. From the spring mounting part 15U-3, a rod-shaped spring supporting part 15U-4 projects forwards in the figure. On the spring supporting part 15U-4, a spring 15U-5 for urging the upper carriage 15U downwards in the figure is mounted.

The linking plate 15U-1 is fixed on an upper surface of the projection part 15U-2 by two screws (not shown) at a holding plate 15U-6 which is mounted thereon. A reference symbol of 15U-6 is a pin for positioning the holding plate 15U-6.

The upper carriage 15U is opened upwards by a disk holder (which will later be described) before inserting of the flexible disk 40. When the flexible disk 40 is inserted in the thin flexible disk drive, the disk holder moves downwards and then the upper carriage 15U closes downwards by the spring 15U-5 so that the upper magnetic head 14a comes close to the magnetic recording medium 41 of the flexible disk 40. When the flexible disk 40 is ejected from the thin flexible disk drive, the upper carriage 15U is held to an opened state upwards by the disk holder which moves upwards.

There is a space between the projection part 15U-2 of the upper carriage 15U and the projection part 15L-2 of the lower carriage 15L and the driving shaft 161 passes through the space. In addition, in this space, the carriage assembly 15 comprises a metal member (not shown) which is engaged with the root of the driving shaft 161. Accordingly, the carriage assembly 15 moves in a longitudinal direction thereof by rotating the driving shaft 161.

In addition, the lower carriage 15L has an intermediate portion in which a thick part 15L-3 is mounted in parallel with the driving shaft 161. The thick part 15L-3 has a through hole through which the guide bar 17 sladably passes. Therefore, the guide bar 17 guides a movement of the carriage assembly 15. In addition, the main frame 13A has a die cutting hole 134a (FIG. 7) in a moving range of the thick part 15L-3 so as to prevent a movement of the carriage assembly 15 because a projection portion of the thick part 15L-3 comes in contact with the main frame 13A. The die cutting hole 134a prevents a size up and down (in a direction of a thickness) of the flexible disk drive from becoming large caused by the projection portion of the thick part 15L-3.

As apparent from FIG. 7, the disk table 11 has a center which is shifted rightwards in the figure from a center line with respect to back and forth in the thin flexible disk drive. In the manner which is described above, the driving shaft 161 of the stepping motor 16 is disposed by using a little space which is formed between a left-hand edge of the main frame 13A and a left-hand edge of the flexible disk 40.

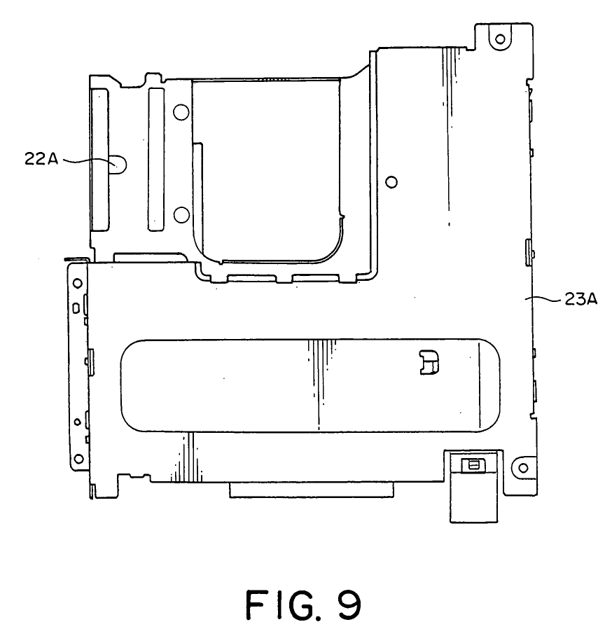

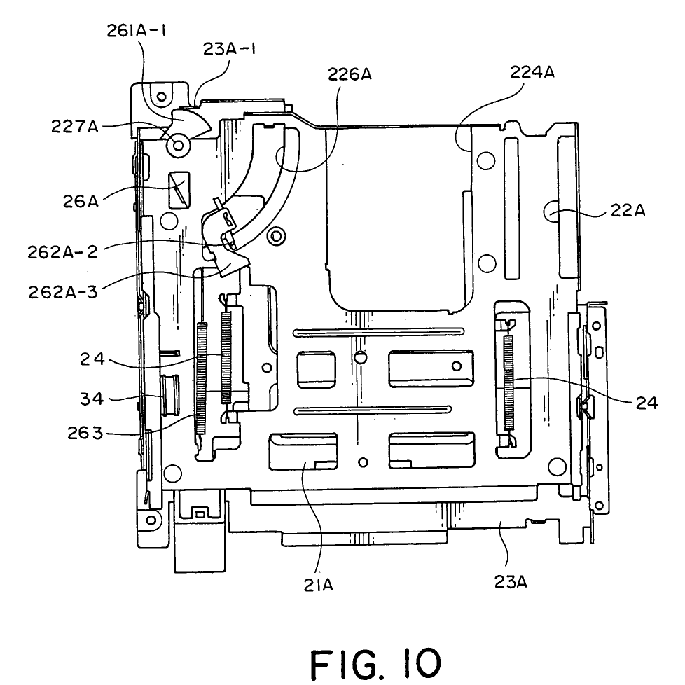

FIGS. 9 and 10 are views for showing an assembled body, which is combined with the main frame 13A, into which an eject base 23A, an eject plate 21A and a disk holder 22A are assembled. FIG. 9 is a plan view of the assembled body while FIG. 10 is a bottom view of the assembled body.

Each of the main frame 13A, the eject plate 21A, the disk holder 22A, and the eject base 23A is formed to perform die cutting, press working, and bending of the a metal plate.

The eject plate 21A is positioned up the main frame 13A and is assembled inside the eject base 23A. The elect plate 13A is mounted on the main frame 13A slidably along the insertion direction A of the flexible disk 40 and an opposite direction (i.e. backward and forward). The disk holder 22A is positioned up the main frame 13A and is assembled inside the eject plate 21A. The eject base 23A is mounted on upper ends of both side plates of the main frame 13A. This mounting is performed by forming a screwed part 135 (FIG. 7) by bending the main frame 13A at the upper ends of the side plate and by screwing up the eject base 23A at the screwed part 135.

As apparent from FIG. 10, between the disk holder 22A and the eject plate 21A, a pair of eject springs 24 is bridged. A disk shutter arm 26A is rotatably mounted to the disk holder 22A. The disk shutter arm 26A is different from the conventional disk shutter arm 26 and is operable not only as an eject lever but also as a head protection structure which will later be described. Accordingly, the disk shutter arm 26A is also called an eject lever in this specification.

The disk shutter arm (the eject lever) 26A is urged by the shutter arm spring 263 counterclockwise (inasmuch as FIG. 10 is the bottom view, the disk shutter arm 26A is urged clockwise in FIG. 10). The shutter arm spring 263 is bridged between the disk shutter arm 26A and the disk holder 22A. The disk shutter arm 26A will be described in more detailed with reference to figures. A combination of the disk shutter arm 26A and the shutter arm spring 263 serves as a shutter driving mechanism for driving the shutter 43 of the flexible disk 40 in an open direction by rotating.

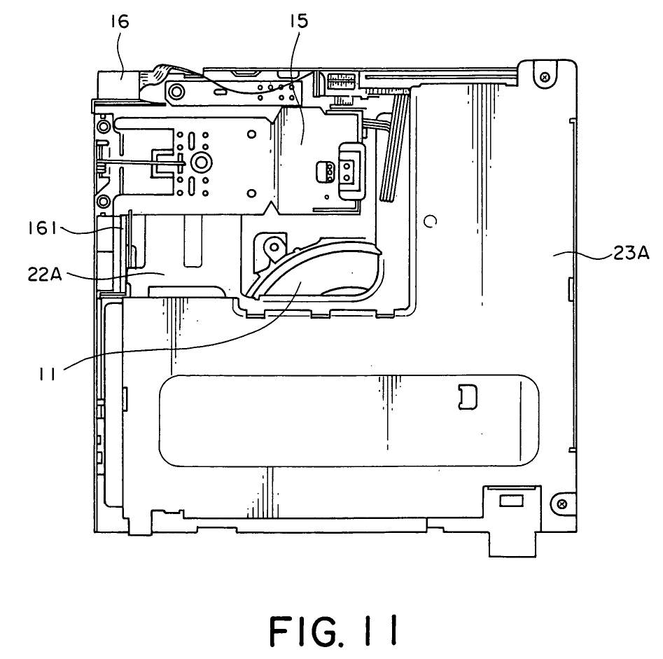

In the thin flexible disk drive according to this embodiment, inasmuch as a slide mechanism (not shown) is provided with both side plates of the eject plate 21A and the eject base 23A and as the eject springs 24 are bridged between the disk holder 22A and the eject plate 21A, the eject base 23A is also used as an upper cover for covering the eject plate 21A except for the moving range of the carriage assembly 15, as illustrated in FIG. 11.

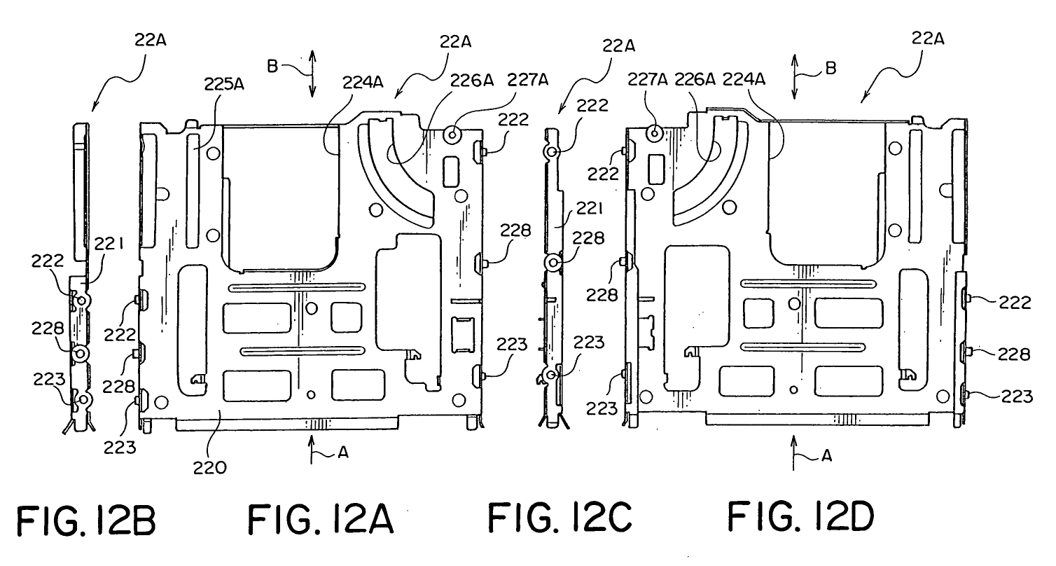

Referring to FIGS. 12A, 12B, 12C, and 12D, the description will proceed to the disk holder 22A. FIG. 12A is a plan view of the disk holder 22A, FIG. 12B is a left side view of the disk holder 22A, FIG. 12C is a right side view of the disk holder 22A, and FIG. 12D is a bottom view of the disk holder 22A.

The disk holder 22A comprises a holder principal surface 220 and a pair of holder side walls 221 which is formed at both side ends of the holder principal surface 220 and which is opposed to each other. Each holder side wall 221 has a tip end which is bent at right angles inwards. Each of the both holder side walls 221 is provided with a pair of projection pins 222 and 223. The projection pins 222 and 223 are inserted in guide slits (not shown) formed on the plate side walls of the eject plate 21A. Furthermore, each of the both holder side walls 221 is provided with a pin 228 which is inserted in a pin control slit (not shown) of the eject base 23A.

In addition, the disk holder 22A has a rectangular opening section 224A extending in the predetermined radial direction B at a little to the left of center in a back or rear side in the insertion direction A. Between the opening section 224A and the left-side edge of the disk holder 22A, a swelled portion 225A extending in a direction of the arrow B is formed where the disk holder 22A swells upwards.

In a state where the flexible disk 40 is ejected from the disk holder 22A, the upper carriage 15U of the carriage assembly 15 engages with the swelled portion 225A, thereby the pair of upper and lower magnetic heads 14a and 14b are apart from each other. In addition, the disk holder 22A has an opening section 226A at a right-hand side of the opening section 224A in the base side of the insertion direction A. The opening section 226A has a substantially quarter ring shape so as to allow a layer bush 262A of the eject lever (the disk shutter arm) 26A (which will later be described) rotatably move. In addition, the disk holder 22A has a right-upper corner part 227A on which the eject lever (the disk shutter arm) 26A is rotatably mounted, as shown in FIG. 10.

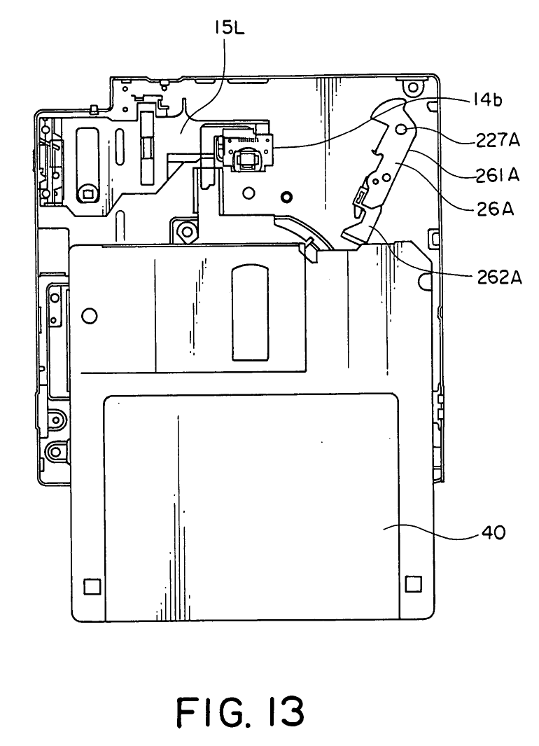

As shown in FIG. 13, the eject lever 26A comprises an arm part (a lever part) 261A extending from the right-upper corner part 227A in a radial direction and the lever bush 262A mounted on a tip portion of the arm part 261A.

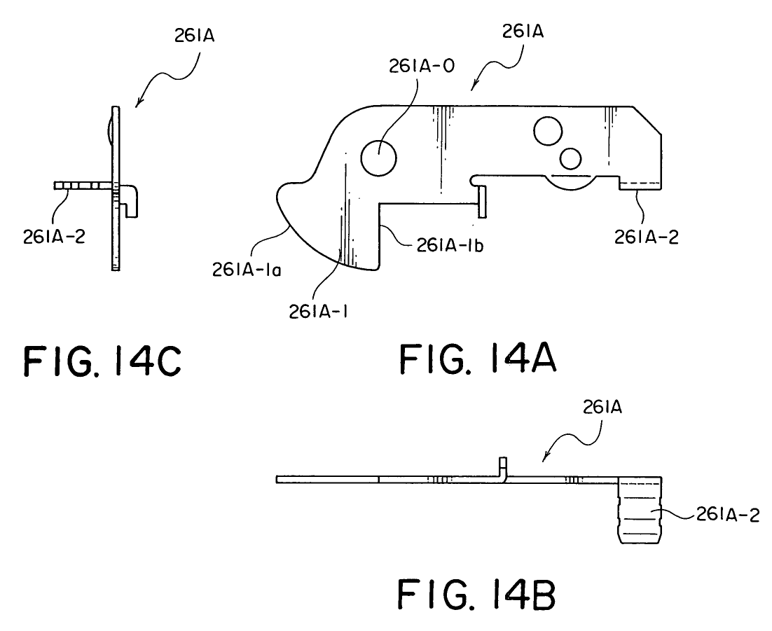

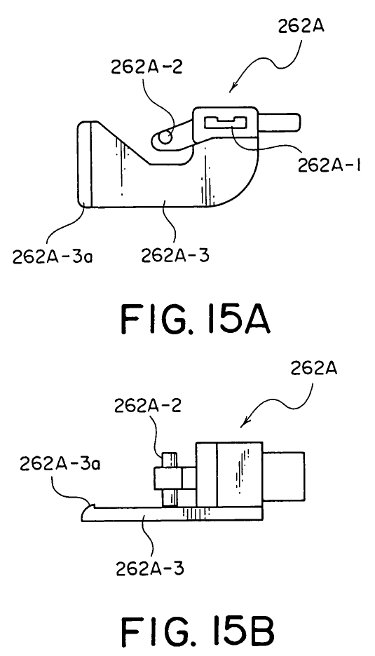

FIGS. 14A, 14B, and 14C collectively show structure of the arm part 261A while FIGS. 15A and 15B collectively show structure of the arm bush 262A. FIG. 14A is a plan view of the arm part 161A, FIG. 14B is a front view of the arm part 161A, and FIG. 14C is a left-hand side view of the arm part 161A. FIG. 15A is a plan view of the arm bush 262A and FIG. 15B is a front view of the arm bush 262A.

As shown in FIGS. 14A to 14C, the arm part 261A has an engaging part 261A-1 engaging with a stopper part 23A-1 (FIG. 10) which is bent at right angles downwards at an end portion of the eject base 23A in a back or rear in the insertion direction A. The engaging part 261A-1 has an arc edge 261A-1a extending in a circumferential direction at a predetermined radius from a rotation axis 261A-0 of the arm part 261A and a radius edge 261A-1b extending in a radial direction toward the rotation axis 261A-0. The arm part 261A further has a tongue part 261A-2 which is bent at right angles downwards at a tip thereof. The tongue part 261A-2 is inserted in an opening part of the lever bush 262A that will later be described.

Referring to FIGS. 15A and 15B, the lever bush 262A is made of resin. The lever bush 262A has the opening part 262A-1 in which the tongue part 261A-2 of the above-mentioned arm part 261A is inserted, as shown in FIG. 15A. The lever bush 262A further has an engaging piece 262A-2 which is engaged with an upper end 43b of a right-hand side edge of the shutter 43 of the flexible disk 40.

The lever bush 262A further comprises a medium catch part (a stopper) 262A-3 for catching a tip end portion (a front edge) of the flexible disk 40 when the flexible disk 40 is inserted in the thin flexible disk drive. That is, the stopper 262A-3 is for supporting the flexible disk 40 at a rear surface thereof so as to avoid crashing the flexible disk 40 with the lower magnetic head 14b on inserting or ejecting of the flexible disk 40. In addition, the stopper 262A-3 has an projection part 262A-3a projecting at a tip thereof upwards. The projection part 262A-3a is for supporting the flexible disk 40 in line contact without plane or face contact.

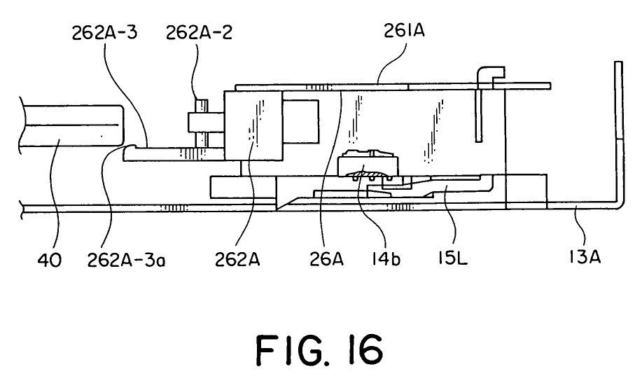

FIG. 16 shows the eject layer 26A in a state where the arm part 261A and the lever bush 262A are assembled. FIG. 16 also illustrates a position relationship between the flexible disk 40 inserted in the thin flexible disk drive and the lower magnetic head 14b mounted on a tip portion of the lower carriage 15L of the carriage assembly 15. Inasmuch as the flexible disk 40 is caught by the stopper 262A-3 of the lever bush 262A at the rear surface thereof when the flexible disk 40 is inserted in the thin flexible disk drive, the rear surface of the flexible disk 40 is always held upwards than a tip of the lower magnetic head 14b. Therefore, on inserting or ejecting of the flexible disk 40, inasmuch as it is possible to prevent the flexible disk 40 from catching or clashing with the lower magnetic head 14b, it is possible to protect the lower magnetic head 14b. In other words, the lever bush 262A of the eject lever 26A can always protect the lower magnetic head 14b with coupled to insertion or ejection of the flexible disk 40. As a result, it is possible to simplify in structure and to cut down a cost because a conventional exclusive lower head guard is not needed.

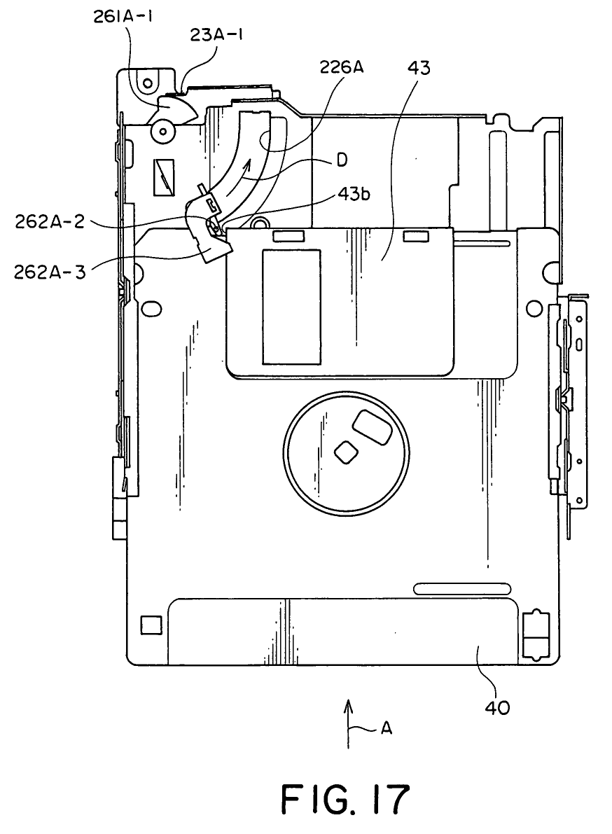

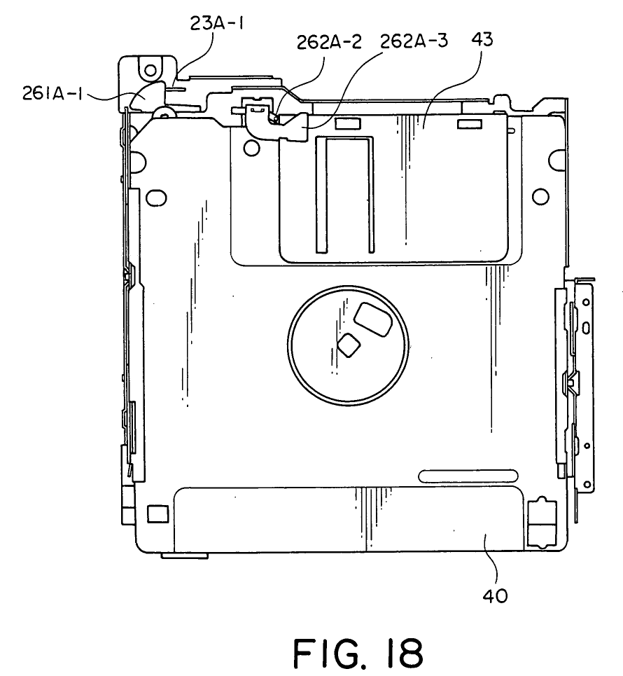

Referring to FIGS. 17 and 18 in addition to FIG. 10, the description will proceed to operation in a case where the flexible disk 40 is loaded in the thin flexible disk drive and operation in a case where the flexible disk 40 is ejected from the thin flexible disk drive. The description will first be made about the operation on loading the flexible disk 40 and subsequently the description will be made about the operation on ejecting the flexible disk 40.

FIG. 17 is a bottom view showing an arrangement relationship between the assembled body and the flexible disk 40 in a state while the flexible disk 40 is inserted in the thin flexible disk drive. FIG. 18 is a bottom view showing an arrangement relationship between the assembled body and the flexible disk 40 in a state where the flexible disk 40 is completely received in the flexible disk drive.

As shown in FIG. 10, before the flexible disk 40 is loaded in the thin flexible disk drive, the arc edge 261A-1a of the engaging part 261A-1 of the eject lever 26A is engaged with an inner wall of the stopper part 23A-1 of the eject base 23A. In this event, the disk holder 22A is put into a risen state. This risen state is a state where the flexible disk 40 can be received in the thin flexible disk drive. Furthermore, in this state, the upper carriage 15U of the carriage assembly 15 is engaged with the swelled portion 225A of the disk holder 22A and the upper magnetic head 14a is put into an upper position apart from the lower magnetic head 14b.

In this state, as shown in FIG. 17, a user holds the flexible disk 40 and inserts the flexible disk 40 in the thin flexible disk drive along the insertion direction A in a normal state with the front edge of the flexible disk 40 put to a door of a front bezel (not shown). In this event, the front portion of the flexible disk 40 is caught by the stopper 262A-3 of the eject lever 26A at the rear surface thereof. Immediately after this, the upper end 43b of the right-hand side edge (an upper end of a left-hand side edge in FIG. 17 because FIG. 17 is the bottom view) in the shutter 43 of the flexible disk 40 engages with the engaging piece 262A-2 of the eject lever 26A.

When the flexible disk 40 is further pushed and put forward from this time instant (place) in opposition to the urging force of the shutter arm spring 263 mounted in the eject lever 26A, the eject lever 26A rotates in the opening portion 226A in a clockwise direction (a counterclockwise direction in FIG. 17 because FIG. 17 is the bottom view) indicated by an arrow D of FIG. 17. Accompanied with this, the shutter 43 of the flexible disk 40 slides in a direction indicated by the arrow C of FIG. 6 in opposition to the urging force of the spring member. Accordingly, the shutter 43 gradually opens the head window 42a.

And then, as shown in FIG. 18, the shutter 43 of the flexible disk 40 sufficiently opens by the eject lever 26A. Just before the flexible disk 40 is substantially and completely received in the thin flexible disk drive, engagement between the arc edge 261A-1a of the engaging part 261A-1 in the eject lever 26A and the inner wall of the stopper portion 23A-1 of the eject base 23A is released. Thereby, the eject plate 21A slightly slides forwards (the opposite direction for the insertion direction A). This is because the eject plate 21A is always urged by the eject springs 24 forwards.

On the other hand, inasmuch as the eject plate 21A slides forwards, the disk holder 22A comes down. This is because the projection pins 222 and 223 formed on the holder side walls 221 of the disk holder 22A are inserted in the guide slits formed in the plate side walls of the eject plate 21A.

Accordingly, engagement between the upper carriage 15U of the carriage assembly 15 and the swelled portion 225A of the disk holder 22A is released and the upper carriage 15U of the carriage assembly 15 comes down. As a result, the magnetic disk medium 41 of the flexible disk 40 is put between the pair of upper and lower magnetic heads 14a and 14b mounted on the carriage assembly 15 at the tip part thereof. In this event, inasmuch as a side edge of the stopper portion 23A-1 of the eject base 23A is engaged with the radius edge 261A-1b of the engaging part 261A-1 of the eject lever 26A, it is possible to prevent the eject lever 26A from returning back to an original position. In addition, inasmuch as the eject plate 21A slightly slides forwards, an eject button (not shown) also slightly protrudes from the front panel (not shown) forwards.

Thereafter, in the manner known in the art, it is possible to read and write data from and in the magnetic disk medium 41 of the flexible disk 40 using the magnetic heads 14a and 14b.

Now, the description will be made about the operation in the case where the flexible disk 40 is ejected from the disk holder 22A.

In this event, the user pushes the eject button in the insertion direction A backwards. Accordingly, the eject plate 21A slides on the eject base 23A in the insertion direction A backwards. With this operation, the projection pins 222 and 223 of the disk holder 22A move along the guide slits of the eject plate 21A and the disk holder 22A comes up. Accordingly, the upper carriage 15U of the carriage assembly 15 is engaged with the swelled portion 225A of the disk holder 22A and the pair of upper and lower magnetic heads 14a and 14b supported on the carriage assembly 15 at the tip part thereof are apart from the magnetic recording medium 41 of the flexible disk 40. When the eject button is furthermore pushed in the insertion direction A backwards, the disk holder 22A is put at a predetermined defined upper position.

At the same time, engagement between the side edge of the stopper portion 23A-1 in the eject base 23A and the radius edge 261A-1b of the engaging part 261A-1 in the eject lever 26A is released and the eject lever 26A rotates, by the urging force of the shutter arm spring 263, counterclockwise (clockwise in FIG. 17 because FIG. 17 is the bottom view) in the opposite direction to the direction indicated by the arrow D of FIG. 17. Accordingly, the flexible disk 40 received in the disk holder 22A is pushed out in the opposite direction to the insertion direction A and the flexible disk 40 is ejected from the thin flexible disk drive. In this state, inasmuch as the arc edge 261A-1a of the engaging part 261A-1 in the eject lever 26A is engaged with the inner wall of the stopper portion 23A-1 in the eject base 23A, it is possible to prevent the eject plate 21A from moving toward the front panel.

According to this invention, in the manner which is described in conjunction with FIGS. 17 and 18, while the flexible disk 40 is inserted on the way and is completely received in the thin flexible disk drive, the front edge of the flexible disk 40 is always caught from the rear surface thereof by the stopper 262A-3 which is integrally formed to the eject lever 26A. Accordingly, it is possible to always protect the lower magnetic head 14b with coupled to insertion and ejection of the flexible disk 40 in the manner which is described above.

Inasmuch as the lever bush 262A is made of resin, the shutter 43 is not injured while the lever bush 262A slides on the shutter 43 of the flexible disk 40. While the front edge of the flexible disk 40 is caught by the stopper 262A-3, the flexible disk 40 is supported on the projection part 262A-3a of the stopper 262A-3. That is, the flexible disk 40 is supported by the projection part 262A-3a in line contact without plane contact. As a result, it is possible to reduce a load (friction) between the flexible disk 40 and the stopper 262A and to move the flexible disk 40 smoothly.

While this invention has thus far been described in conjunction with a preferred embodiment thereof, it is to be understood that modifications will be apparent to those skilled in the art without departing from the sprit of the invention. For example, this invention may be applicable to a thin flexible disk drive comprising a carriage assembly which extends in parallel with a driving shaft of a stepping motor.

What is claimed is:

1. A thin flexible disk drive in which a flexible disk is inserted, said flexible disk comprising a slidable shutter, said thin flexible disk drive comprising:
upper and lower magnetic heads which are disposed in a portion corresponding to said slidable shutter when said flexible disk is inserted in said thin flexible disk drive;
a disk holder for holding said flexible disk;
a shutter driving mechanism having an arm engaged with a corner portion of said shutter when said flexible disk is inserted in said thin flexible disk drive, said shutter driving mechanism driving said shutter so as to open said shutter by rotating said arm, said shutter driving mechanism being rotatably mounted on said disk holder; and
a stopper integrally formed to said arm near a tip of said arm, said stopper supporting said flexible disk at a rear surface thereof so as to avoid crashing said flexible disk with said lower magnetic head on inserting/ejecting said flexible disk in/from said thin flexible disk drive.

2. A thin flexible disk drive as claimed in claim 1, wherein said stopper is made of resin.

3. A thin flexible disk drive as claimed in claim 1, wherein said stopper has a projection part projecting at a tip thereof upwards so that said projection part supports said flexible disk in line contact.

4. A thin flexible disk drive as claimed in claim 1, wherein said arm serves also as an eject lever for ejecting said flexible disk from said thin flexible disk drive.
